(19) United States
(12) Patent Application Publication
(10) Pub. No.: US 2009/0237829 A1
(43) Pub. Date: Sep. 24, 2009

(54) INFORMATION RECORDING MEDIUM

(75) Inventors: Yasuyuki Ozawa, Kawasaki (JP); Haruhiko Izumi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/276,022

(22) Filed: Nov. 21, 2008

(30) Foreign Application Priority Data
Mar. 18, 2008 (JP) 2008-069356

(51) Int. Cl. G11B 21/02; G11B 5/82

(52) U.S. Cl. 360/75; 360/135; G9B/5.293; G9B/21.003

(57) ABSTRACT

An information recording medium has a substrate, first recording dots, and second recording dots. The first recording dots are arranged in an array circumferentially in accordance with a predetermined regulation at mutual intervals in accordance with the regulation at a position in accordance with the regulation, and are used to magnetically record information. The second recording dots are arranged in an array circumferentially in accordance with the regulation at mutual intervals in accordance with the regulation. In the second recording dots, plural kinds of positions having different deviation amounts from the position in accordance with the regulation appear in one round of the array. The second recording dots are also used to magnetically record information.

### CROSS-REFERENCE TO RELATED APPLICATION

This application is based upon and claims the benefit of priority of the prior Japanese Patent Application No. 2008-069356, filed on Mar. 18, 2008, the entire contents of which are incorporated herein by reference.

### FIELD

The embodiments discussed herein are directed to an information recording medium and an information storage device having the information recording medium.

### BACKGROUND

Attention is recently paid to a patterned media type magnetic disk as a technique for improving the recording density of an information recording medium mounted on an information storage device. The patterned media type magnetic disk has a structure in which dots each made of a magnetic material for storing a minimum unit of information are arranged in a regular array on the disk.

FIG. 1 is a perspective view schematically illustrating the structure of a patterned media type magnetic disk. Illustrated in FIG. 1 is apart cut from a disk-shaped magnetic disk.

A magnetic disk D illustrated in FIG. 1 has a structure in which plural recording dots Q are arranged in a regular array on a substrate S, and information corresponding to one bit is magnetically recorded on each of the recording dots Q. The recording dots are arranged circumferentially around the center of a disk, and a row of the recording dots forms a track T. Such a patterned media type magnetic disk is generally manufactured by a publicly known manufacturing process called “nanoimprint lithography”. Since the present invention does not directly relate to a manufacturing process, description on the manufacturing process is omitted.

A magnetic disk device having a general magnetic disk, not limited to a patterned media type one, mounted thereon records and reproduces target information by positioning a magnetic head using a servo pattern on the magnetic disk. On a track of the magnetic disk, a servo region in which a servo pattern is arranged and a data region in which data is recorded are alternately arranged along the track. From the magnetic head relatively moving along the track of the rotating magnetic disk, a servo pattern is read at a servo sampling frequency represented by (the number of servo regions per rotation×the number of rotations of the magnetic disk) to obtain position information of the magnetic head. Based on the position information, servo control in a discrete time region is performed, so that the magnetic head follows the target track.

FIGS. 2A and 2B illustrate general arrangement of regions in a magnetic disk. The regions of a magnetic disk 90 are illustrated together with a magnetic head in FIG. 2A, and a partial region R of the magnetic disk 90 is illustrated in linear development in FIG. 2B on an enlarged scale.

The regions on the magnetic disk 90 are partitioned into plural zones from a zone 0 to a zone i in the radius direction, and are used. In one zone, the length of a recording region per bit gradually becomes long from the inner round towards the outer round because the recording frequency is constant. However, in order to restrict the length of the recording region per bit for every zone within a given range, a structure (zoned CAV method) is employed in which the further outside the zone is positioned, the higher the recording frequency is. A sector is composed of a servo region and a data region following this servo region. Note that as illustrated in FIG. 2A, a magnetic head 91 is attached to the leading edge of an arm 92, and strictly speaking, a servo region is arranged in a circular-arc shape along a locus 93 of the magnetic head moving in accordance with rotation of the arm.

As opposed to the patterned media type magnetic disk, in a continuous media type magnetic disk that has been widely used, a servo region and a data region are provided in a magnetic film extending uniformly and continuously. On the other hand, in the patterned media type magnetic disk, a pattern of magnetic area/non-magnetic area in accordance with servo information has been formed in a servo region by the manufacturing process, and becomes a magnetic pattern representing the servo information when the entire servo region is uniformly magnetized. Minute recording dots are discretely arranged in a data region. One recording dot corresponds to one bit of information, and the bit value is represented by the magnetizing direction. In the patterned media type magnetic disk, information cannot be recorded between recording dots, and therefore recording of information needs to be performed after a magnetic head has been positioned accurately above the a recording dot. This positioning includes positioning a recording head in the radius direction of a magnetic disk and synchronizing the timing of supplying a signal to the recording head and the timing of reading a signal from the recording head with the timing of passing the recording dot.

FIG. 3 explains the relationship between recording dots of a patterned media type magnetic disk and write clocks.

As illustrated in FIG. 3, when recording information on a patterned media type magnetic disk, it is necessary to generate a write clock in synchronization with a timing at which the magnetic head 95 passes the recording dot Q and to supply write data to the magnetic head 95 in synchronization with the write clock. The synchronization used here includes the same period and the same phase. For example, both the periods of a write clock C1 and a write clock C2 illustrated in FIG. 3 are the same as the period in which the magnetic head 95 passes the recording dot Q, but the phases of the write clock C1 and the write clock C2 deviate from each other. As a result, if a signal is supplied to the magnetic head 95 based on the timing of the appropriate write clock C1, information is recorded on the recording dot Q; however, if a signal is supplied based on the timing of the inappropriate write clock C2, information is not normally recorded.

As a technique for producing a write clock in synchronization with a timing of passing a recording dot, a technique of providing a write preamble serving as the timing reference on a magnetic disk is proposed, e.g., in Japanese Laid-open Patent Publication No. 2003-157507.

FIG. 4 illustrates part of a patterned media type magnetic disk in which a write preamble is provided.

On the magnetic disk illustrated in FIG. 4, a write preamble 96 made of a pattern of a magnetic material is provided adjacent to a data region. If a read head for reading information of a magnetic disk device is also used as a write head that writes information, a write clock having a period and a phase in synchronization with a signal read when the head passes the write preamble 96 can be generated.

However, with a magnetic disk device in which a read head and a write head are separately provided in a magnetic head, synchronization is more difficult. In a magnetic head illustrated in FIG. 4, a read head 98a and a write head 98b are separately provided. A distance G between the read head 98a and the write head 98b generally corresponds to several tens of tracks, and has a deviation for each product. The read head 98a and the write head 98b are attached to a rotating arm 99 to be arranged obliquely to the track, and therefore effects of the distance G between the read head 98a and the write head 98b and the deviation appear both in the circumferential direction along which recording dots are arranged and in the radius direction that intersects the circumferential direction.

In a magnetic disk device having a configuration where a read head and a write head are separated, when a write preamble is read by the read head and a write clock is locked to the read signal by a phase locked loop (PLL) circuit or the like, the period of the write clock (C4 of FIG. 4) becomes the same as the period of a timing (C3 of FIG. 4) at which the write head passes a recording dot, but their phases do not become the same. For example, in Japanese Laid-open Patent Publication No. 2006-164349, in order to adjust the positional relationship in the circumferential direction, i.e., to adjust the phase difference between the write clock and the timing of passing a recording dot, a method is proposed that records information while changing the phase of the write clock to search for the optimum phase.

Regarding the deviation in the radius direction, there is a problem specific to a patterned media type magnetic disk in addition to one with a continuous media type magnetic disk. As described above, the distance G between the read head 98a and the write head 98b generally corresponds to several tens of tracks, and has a deviation for each product. This state is the same as in a continuous media type magnetic disk. In the continuous media type magnetic disk, however, a write head is positioned at an arbitrary position and information is recorded as trial write, and thereafter the recorded information is read while the position of a read head is changed in N ways to detect the position at which signals representing information are most efficiently read, thus enabling the distance G (see FIG. 4) between the read head 98a and the write head 98b to be accurately measured. If G is measured, appropriate recording is enabled by adjustment of a relative positional relationship between the write head and the read head. For measurement of G, it is necessary to perform recording corresponding to one rotation of a magnetic disk and to read information while changing the position of a read head in N ways. Given that one disk rotation is needed to read information for one way of the position of the read head, the number of rotations NT of the magnetic disk needed to obtain an appropriate position of the magnetic head is expressed by the following.

NT=1+N

In contrast, in the patterned media type magnetic disk, for example, when the first trial write is performed to a portion between recording dots, this may result in a failure to record information on a recording dot although the phase of a write clock in the circumferential direction is proper. In this case, the relative distance G (see FIG. 4) cannot be measured by trial of NT (=1+N) rotations.

Thus, in the patterned media type magnetic disk, the positional relationship needs to be adjusted both in the circumferential direction and in the radius direction.

In the patterned media type magnetic disk, however, there are two conditions for disk access that are to be adjusted, i.e., the phase of a write clock and the positional relationship in the radius direction between a write head and a recording dot. This increases combination patterns of access conditions to be changed in trial write and read. For example, even though the period and the phase of a write clock are appropriate, there is no assurance that information is recorded on recording dots. In addition, it cannot be determined whether the cause of information not recorded on recording dots is a deviation in the radius direction or a deviation in the circumferential direction, i.e., a phase deviation of a write clock.

If assuming that the position of a read head is changed over N tracks, the position in the radius direction of a write head is changed in M ways, and the phase of a write clock is changed in L ways, the optimum access conditions are to be determined among these conditions, the needed number of rotation NT of a magnetic disk is expressed by the following.

NT=(1+N)×M×L

Therefore, there is a problem in that a long time is needed for determining the optimum access conditions in an adjustment.

### SUMMARY

An information recording medium, includes: a substrate; first recording dots which are arranged in an array circumferentially in accordance with a predetermined regulation at mutual intervals in accordance with the regulation at a position in accordance with the regulation and are used to magnetically record information; and second recording dots which are arranged in an array circumferentially in accordance with the regulation at mutual intervals in accordance with the regulation, in which plural kinds of positions having different deviation amounts from the position in accordance with the regulation appear in one round of the array, and which are used to magnetically record information.

Objects and advantages of the embodiments will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a perspective view schematically illustrating the structure of a patterned media type magnetic disk;

FIGS. 2A and 2B illustrate general arrangement of regions in the magnetic disk;

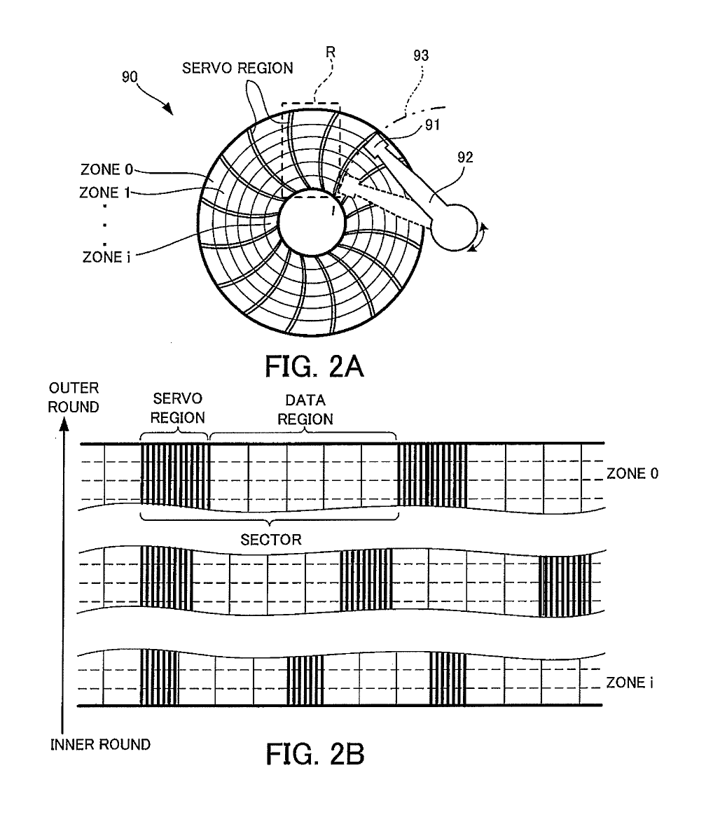

FIG. 3 explains the relationship between recording dots of a patterned media type magnetic disk and write clocks;

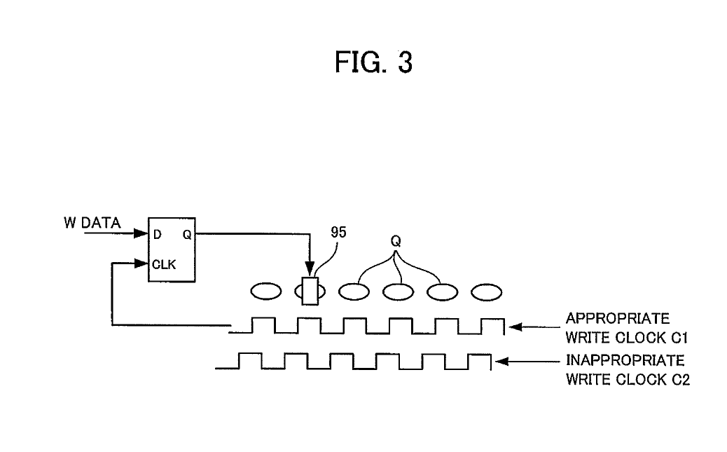

FIG. 4 illustrates part of a patterned media type magnetic disk in which a write preamble is provided;

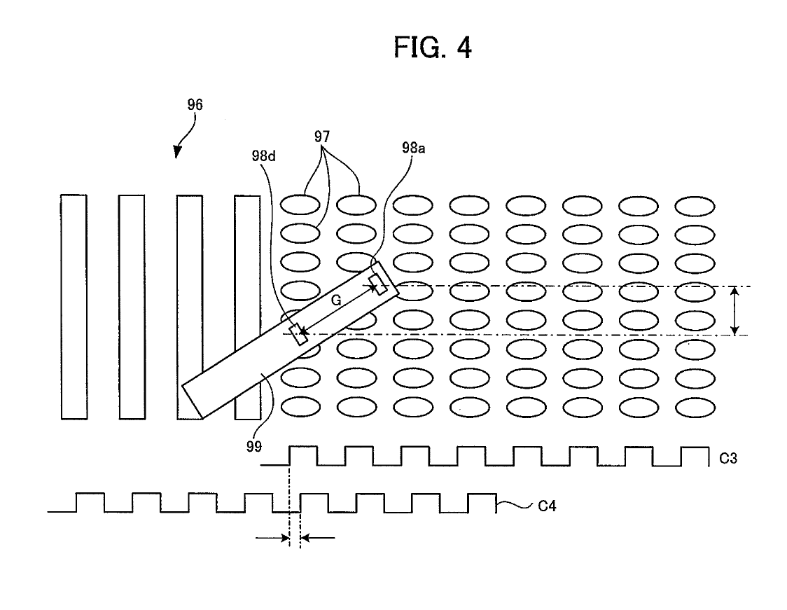

FIG. 5 illustrates a hard disk device (HDD) being a specific first embodiment of an information storage device;

FIG. 6 illustrates the details of the magnetic disk illustrated in FIG. 5;

FIG. 7 is a flow chart for explaining the process of determining the optimum access conditions to the magnetic disk illustrated in FIG. 6 in the magnetic disk device illustrated in FIG. 5;

FIG. 8 illustrates a magnetic disk of a HDD being a specific second embodiment of the information storage device;

FIG. 9 is a flow chart for explaining the process of determining the optimum access conditions to the magnetic disk illustrated in FIG. 8;

FIG. 10 illustrates a magnetic disk of a HDD being a specific third embodiment of the information storage device;

FIG. 11 is a flow chart for explaining the process of determining the optimum access conditions to the magnetic disk illustrated in FIG. 10;

FIG. 12 illustrates a magnetic disk of a HDD being a specific fourth embodiment of the information storage device; and

FIG. 13 is a flow chart for explaining the process of determining the optimum access conditions to the magnetic disk illustrated in FIG. 12.

### DESCRIPTION OF EMBODIMENTS

Specific embodiments of an information recording medium and an information storage device will be described below with reference to the drawings.

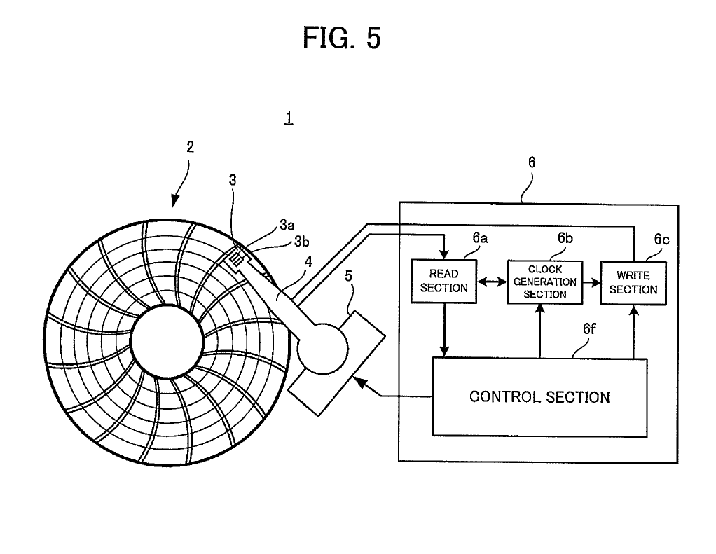

FIG. 5 illustrates a HDD being the specific first embodiment of the information storage device.

A HDD 1 includes a disk-shaped magnetic disk 2, a magnetic head 3 that reads and writes information on the magnetic disk 2, an arm 4 that moves the magnetic head 3 in the radius direction of the magnetic disk, an arm drive section 5 that rotates and drives the arm 4, and a control circuit 6 that controls components of the HDD 1 and that receives and transmits signals from and to the magnetic head 3. The magnetic disk 2 corresponds to one example of the information recording medium described above. The magnetic head 3 includes a read head 3a and a write head 3b, and the read head 3a and the write head 3b are disposed with an interval there between.

The control circuit 6 includes a read section 6a that receives signals output from the read head 3a, a write section 6c that supplies to the write head 3b signals of information to be recorded, a clock generation section 6b that supplies a read clock to the read section 6a and supplies a write clock to the write section 6c, and a control section 6f that controls the whole control circuit 6 and that drives the arm drive section 5 to move the magnetic head 3. The read section 6a supplies to the clock generation section 6b signals that are read when the read head 3a passes a write preamble. The clock generation section 6b has a PLL circuit, and generates a read clock having a period and a phase that are the same as those of a signal of a write preamble supplied from the read section 6a and also generates a write clock being identical in period and shifted in phase to the signal of the write preamble. The shift in phase between the read clock and the write clock is set by the control section 6f. The control section 6f has a memory, and stores the amplitude of a read signal of a recording dot supplied from the read section 6a, determines conditions in which the amplitude becomes maximum, and, based on the determined conditions, sets the positions of the read head 3a and the write head 3b by drive of the arm drive section 5 and the amount of phase shift of the write clock.

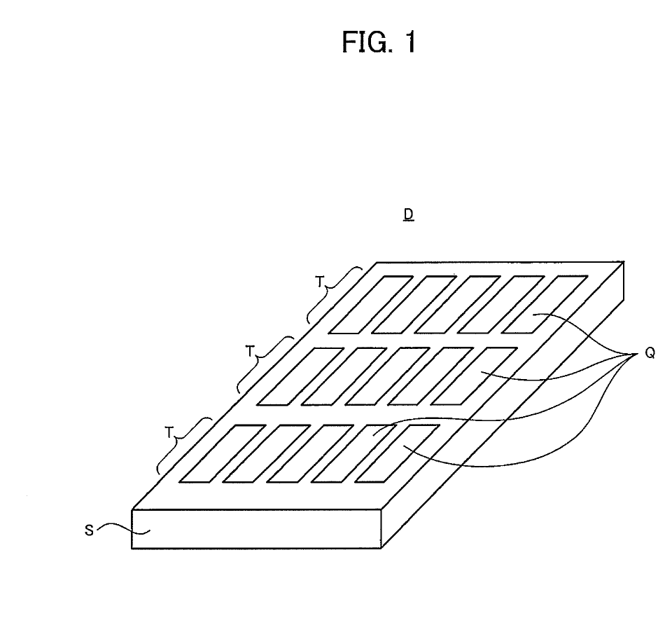

The magnetic disk 2 is a patterned media type magnetic disk, and its basic structure having a substrate S and plural recording dots Q arrayed on the substrate S is the same as that described referring to FIG. 1.

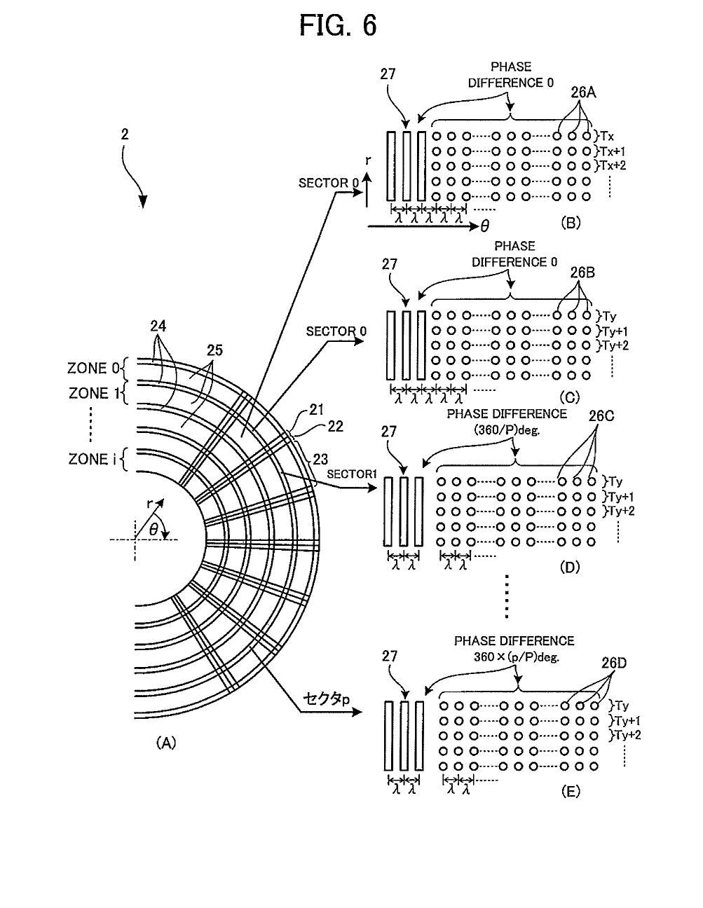

FIG. 6 illustrates the details of the magnetic disk illustrated in FIG. 5. A half of the magnetic disk 2 is illustrated in Part (A) of FIG. 6, and tracks in plural portions on the magnetic disk 2 are illustrated in linear development in Parts (B) to (E) of FIG. 6 on an enlarged scale.

On the magnetic disk 2, tracks T (Tₓ, Tₓ₊₁, Tₓ₊₂, . . . , T_{y}, T_{y+1}, T_{y+2}, . . . ) are formed of rows of recording dots arranged on the circumferences. Each track is separated by a servo region 21 in which a servo pattern is arranged. In the track, a portion from one servo region to just in front of the next servo region is termed a “sector”. In an example of magnetic disk 2 illustrated in FIG. 6, P sectors are provided and numbers from 0 (zero) to (P−1) are assigned to the sectors. Each sector has the servo region 21, a preamble region 22 and a data recording region 23. In the example of the magnetic disk 2 illustrated in FIG. 6, the preamble region 22 is disposed between the servo region 21 and the data recording region 23. The regions on the magnetic disk 2 are partitioned into plural zones from the zone “0” to the zone “i” in the radius direction. Each zone has a trial write region 24 and an information storage region 25, and the trial write region 24 and the information storage region 25 partition each zone in the radius direction. In the example of the magnetic disk 2 illustrated in FIG. 6, among plural tracks belonging to each zone, inside tracks Tₓ, Tₓ₊₁, Tₓ₊₂, . . . belong to the information storage region 25 and outside tracks T_{y}, T_{y+1}, T_{y+2}, . . . belong to the trial write region 24. Both a track belonging to the trial write region 24 and a track belonging to the information storage region 25 each have P sectors from the 0th sector to (P−1) th sector. Each sector has the servo region 21, the preamble region 22 and the data recording region 23. Formed in the servo region 21 is a pattern made of a magnetic material. The pattern is magnetized upon manufacturing of the magnetic disk 2 to form a magnetic pattern representing information for identifying the track T. Formed in the preamble region 22 are write preambles 27 for generating a reference for the timing for writing information. The write preambles 27 are formed of a pattern made of a magnetic material. The pattern is magnetized upon manufacturing of the magnetic disk 2 to form a magnetic pattern. The write preambles 27 are written at least in the trial write region 24 and the information storage region 25 with the common period and the common phase. Arranged in the data recording region 23 are recording dots made of a magnetic material in which information is stored. Illustrated in Part (B) of FIG. 6 are the write preambles 27 and the first recording dots 26A in the sector 0 of tracks Tₓ, Tₓ₊₁, Tₓ₊₂, . . . provided in the information storage region 25 of the zone 1 of the magnetic disk 2.

The first recording dots 26A are arranged in an array circumferentially in accordance with a predetermined regulation. In more detail, the first recording dots 26A are arranged on plural concentric tracks T (Tₓ, Tₓ₊₁, Tₓ₊₂, . . . ). The first recording dots 26A are arrayed, in one zone, at mutual intervals in accordance with the predetermined regulation to allow reading with a common read clock and writing with a common write clock. In more detail, in one zone, the same number of first recording dots 26A are arranged in each track T (Tₓ, Tₓ₊₁, Tₓ₊₂, . . . ). That is, the first recording dots 26A are arranged, in one zone, at regular mutual intervals with respect to an angle θ from the center of the magnetic disk 2, i.e., at equiangular intervals. With attention given to the individual track T (Tₓ, Tₓ₊₁, Tₓ₊₂, . . . ), the first recording dots 26A are arranged at equal intervals on the track T. When in the HDD 1, the magnetic disk 2 rotates for the read head 3a or the write head 3b to relatively move on the track T, the time period in which the read head 3a or the write head 3b passes the recording dot 26A is constant in any track T in one zone. Therefore, the interval between the recording dots 26A adjacent to each other in the circumferential direction in one zone is termed a “period λ” in the meaning that the time period for passing a head is equal. Further, the first recording dots 26A are arrayed at a position in accordance with the regulation. In more detail, all the first recording dots 26A are arranged at equiangular intervals and are arranged on circular tracks. The fact that all the first recording dots 26A arranged at equiangular intervals means that the first recording dots 26A are at a reference position arranged in the period λ on tracks.

The write preambles 27 as viewed in the circumferential direction are arranged at regular mutual intervals with respect to the angle θ from the center of the magnetic disk 2. In an example illustrated in FIG. 6, the write preambles 27 are arrayed at mutual intervals having a relationship of 1:1 to those of the first recording dots 26A on the same track. That is, the write preambles 27 are arranged with the period λ. Also, at a position where the write preamble 27 and the first recording dot 26A are adjacent to each other, the write preamble 27 and the first recording dot 26A are arrayed at an interval of the period λ. That is, the write preambles 27, just as the first recording dots 26A, are on the reference position arranged with the period λ on a track. This means that the first recording dots 26A and the write preambles 27 are arranged at the position with a phase difference of 0 degree with respect to the period λ of the array.

Accordingly, in the case where the read head 3a of the magnetic disk device 1 relatively moves along any one of the tracks T (Tₓ, Tₓ₊₁, Tₓ₊₂, . . . ) illustrated in Part (B) of FIG. 6, when a read clock having a period and a phase in synchronization with a signal read from the read head 3a passing the write preamble 27 is generated, the period and phase of the read clock are the same as those of the timing at which the read head 3a passes the first recording dot 26A. Reading from the first recording dot 26A can therefore be performed in synchronization with the read clock that is in synchronization with the read signal of the write preamble 27. However, the read head 3a and the write head 3b are distant from each other, and therefore the phase of the read clock is not the same as that of the timing at which the write head 3b passes the first recording dot 26A. In order to appropriately record information on the first recording dot 26A, a write clock having the same phase as that of the timing at which the write head 3b passes the first recording dot 26A is needed.

As illustrated in Parts (C) to (E) of FIG. 6, second recording dots 26B, 26C and 26D are arrayed following the write preambles 27 on the tracks T_{y}, T_{y+1}, T_{y+2}, . . . in the trial write region 24.

The second recording dots 26B in the sector 0 in the trial write region 24 are arranged in an array, circumferentially in accordance with the same predetermined regulation as that of the first recording dots 26A arranged in the information storage region 25, at mutual intervals in accordance with the regulation at a position in accordance with the regulation. Accordingly, the second recording dots 26B are arranged at a position with a phase difference of 0 degree with respect to the write preambles 27.

On the other hand, the second recording dots 26C in a sector 1 in the trial write region 24 are arranged in an array circumferentially in accordance with the same predetermined regulation as that of the second recording dots 26B arranged in the sector 0 at mutual intervals in accordance with the regulation; however, they are arranged at a position deviating in a direction along the round of the array from the position in accordance with the regulation. In more detail, the second recording dots 26C in the sector 1 are arranged with a phase shift of 360/P degrees with respect to the reference position with the period λ following the write preambles 27 on the track. That is, the second recording dots 26C in the sector 1 are arranged at a position with a phase difference of 360/P degrees with respect to the write preambles 27.

The second recording dots 26B, 26C and 26D in the trial write region 24 appear at plural positions with different deviation amounts. In more detail, the deviation amounts of the second recording dots 26B, 26C and 26D with respect to the reference position with the period λ following the write preambles 27 increase by 360/P degrees per sector. For example, as illustrated in Part (E) of FIG. 6, the second recording dots 26D in a sector “p” are arranged at a position with a phase difference of 360p/P degrees with respect to the write preambles 27.

Here, description is given on a process of determining the optimum access conditions to the first recording dots 26A in the information storage region 25 with the magnetic disk device 1 illustrated in FIG. 5.

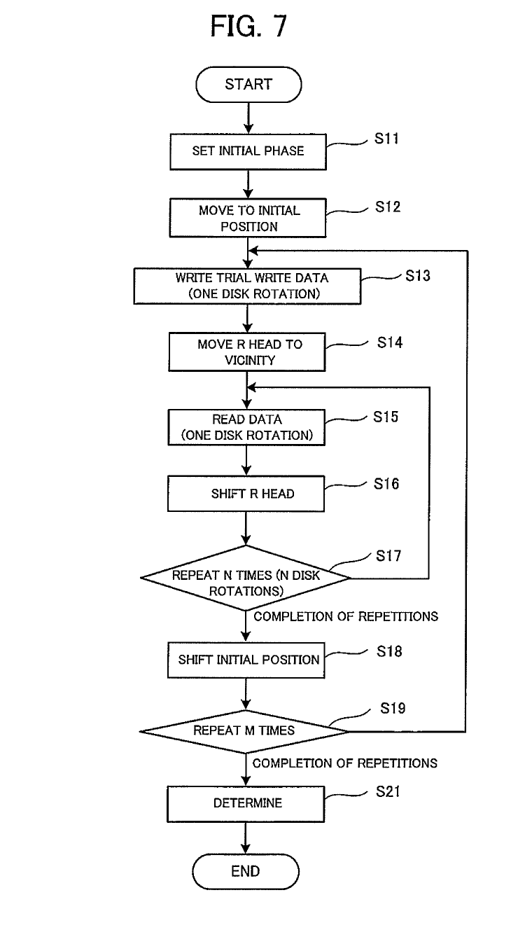

FIG. 7 is a flow chart for explaining the process of determining the optimum access conditions to the magnetic disk illustrated in FIG. 6 in the magnetic disk device 1 illustrated in FIG. 5. In this process, data is read and written while each of the track read by the read head 3a, the position in the radius direction of the write head 3b, and the phase of a write clock is gradually changed, thereby determining conditions in which the amplitude of a signal read from the read head 3a becomes maximum.

If the phase of a timing at which the write head 3b passes a recording dot and the phase of a write clock become the same, and the shifted position in the radius direction of the write head 3b and the track T_{y} become the same, the recording efficiency of information, that is, the degree to which a recording dot is magnetized becomes maximum. In the process of FIG. 7, access conditions are determined in which the signal amplitude value becomes maximum.

First, the control section 6f of the control circuit 6 sets an initial phase, which is an initial value of the phase difference between a read clock and a write clock, in a clock generation section 6b (S11). The phase difference is to be changed later, and therefore an arbitrary value can be selected as the initial value. For example, if 0 is set as the initial value, the read clock and the write clock generated by the clock generation section 6b have the same phase.

Next, the control circuit 6 drives the arm drive section 5 to move the write head 3b of the magnetic head 3 to the initial position of trial write (S12). Specifically, the write head 3b is moved with the objective of any track, e.g., the track T_{y}, in the trial write region 24. Movement of the write head 3b, in more detail, is performed by positioning the read head 3a so that the write head 3b is positioned in the vicinity of the objective track T_{y} while reading a servo pattern on the magnetic disk 2 by the read head 3a. However, the interval between the read head 3a and the write head 3b has a deviation per product as described above. The initial position of the write head 3b may be positioned in the vicinity of a track different from the object track T_{y}, and further may be positioned between tracks.

Next, data is written to a trial write region (S13). In more detail, test data is written over one round at a position to which the write head 3b has moved with the objective of the track T_{y}. In writing of data, the clock generation section 6b generates a read clock having the same period and phase as those of a signal read by the read head 3a upon passing of the write preamble 27, and also generates a write clock having the same period as that of this read clock and having the set phase difference.

For example, if the phase difference is set to 0, the write clock has the same phase as that of a signal read by the read head 3a upon passing of the write preamble 27. The write section 6c supplies test data to the write head 3b in synchronization with the generated write clock. Thus, information is recorded on the magnetic disk 2 in the same period as that in which the pattern of the write preamble 27 passes.

Next, the read head 3a is moved to the track T_{y} in the trial write region 24 to which write has been performed (S14). In more detail, the read head 3a is positioned at the track T_{y} while a servo pattern is read.

Next, data is read (S15). Data is read from the track T_{y} in the trial write region 24 by the read head 3a. Data is read from all the sectors ranging from 0th sector to (P−1) th sector on the track T_{y}. The control circuit 6f measures amplitudes of signals output through the read section 6a from the read head 3a, and stores the representative value of the amplitude for each sector. That is, at this point, P amplitudes are stored that correspond to the second recording dots arranged in P sectors with the phase differences deviating by 360/P degrees.

Next, the control circuit 6f shifts the position of the read head 3a to the next track (S16), and the process from step S13 is repeated. The process from step S13 is repeated a number of times corresponding to N tracks. This allows signal amplitude values to be obtained for the objective track and the adjoining track.

After repeating the process N times, the control circuit 6f finely shifts the position of the write head 3b by a distance less than the track interval, more specifically, only by 1/M of the distance between recording dots in a radius direction r (S18), and then the process from step S12 is performed again (S19). Steps from S12 to S18 are repeated M times with the position of the write head 3b being finely shifted.

At the point when M repetitions have been completed, P signal amplitude values corresponding to 0th to (P−1) th sectors are measured N times while the position of the read head 3a is shifted. The N measurements are repeated M times while the position of the write head 3b is finely shifted. As a result, P×N×M signal amplitude values are obtained.

Here, the control circuit 6f determines optimum conditions (S21). The control circuit 6f searches for conditions for a signal amplitude value being maximum among the stored P×N×M signal amplitude values. The signal amplitude value becomes maximum if the phase of the timing at which the write head 3b passes a recording dot and the phase of a write clock become the same, the shifted position in the radius direction of the write head 3b and any track T_{y} become the same, and further the read head 3a reads data from the track T_{y}, The control circuit 6f stores the phase difference of the sector, the shift amount of the read head 3a and the fine shift amount of the write head 3b with which the maximum signal amplitude value is obtained.

When writing information in the information storage region 25, the control section 6f corrects the phase of the write clock and the position of the write head 3b during writing with the stored phase difference, shift amount of the read head 3a and fine shift amount of the write head 3b. In this way, the optimum access conditions to the magnetic disk are obtained.

In the above process, the magnetic disk makes one revolution when data is written in step S13, and also makes one revolution when data is read in step S15. As a result, the number of rotations of the magnetic disk to determine the optimum access conditions is (1+N)×M. This reduces the number of rotations of a magnetic disk for adjustment, compared with the number of rotations of (1+N)×M×L, which is needed in the case of a magnetic disk without recording dots differing from one another in phase difference as described in “BACKGROUND”.

Next, a second embodiment of the information storage device and the information recording medium will be described. In the following description on the second embodiment, the same elements as those in the embodiment that has been described are indicated by the same reference numerals, and description is given on the differences from the foregoing embodiment.

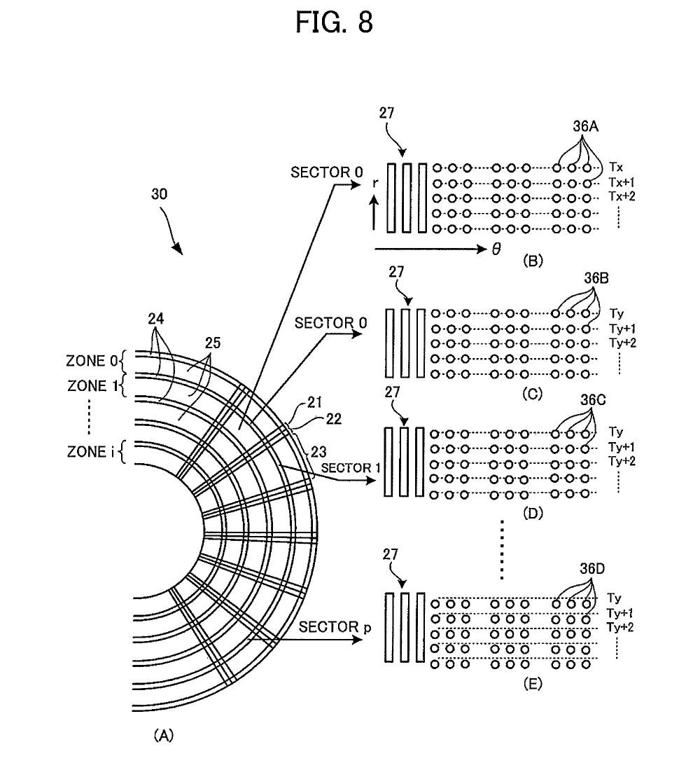

FIG. 8 illustrates the magnetic disk of a HDD being the specific second embodiment of the information storage device.

A half of a magnetic disk 30 is illustrated in Part (A) of FIG. 8, and tracks in plural portions on the magnetic disk 30 are illustrated in linear development in Parts (B) to (E) of FIG. 8 on an enlarged scale.

The HDD in the second embodiment differs from the HDD in the first embodiment only in arrangement of recording dots in the trial write region of the magnetic disk and operations for determining the optimum access conditions. Therefore, only the magnetic disk is illustrated in the drawing, and other configurations are described by utilizing FIG. 5 in the embodiment that has been described.

On the magnetic disk 30, recording dots 36B, 36C and 36D, following the write preambles 27, are arranged in regular arrays on the tracks T_{y}, T_{y+1}, T_{y+2}, . . . in the trial write region 24.

However, in the magnetic disk 30 of the present embodiment, as compared with the magnetic disk 2 of the first embodiment, the phase differences of the second recording dots 36B, 36C and 36D with respect to the write preambles 27 are all 0 degree, the same as the phase differences of the first recording dots 36A in the information storage region 25. On the other hand, the second recording dots 36B, 36C and 36D of each of sectors in the trial write region 24 are arranged, on each of tracks T_{y}, T_{y+1}, T_{y+2}, . . . , at positions deviating, from the positions in accordance with the regulation of the array of the first recording dots 36A in the information storage region 25, in the radius direction intersecting the circumferential direction of this array. The second recording dots 36B, 36C and 36D are arranged at plural positions with deviation amounts in the radius direction that are different for each sector. In more detail, the positions of the second recording dots 36B, 36C and 36D deviate towards the center by 1/P of the width between tracks, as the number of the sector in which the second recording dots are arranged increases.

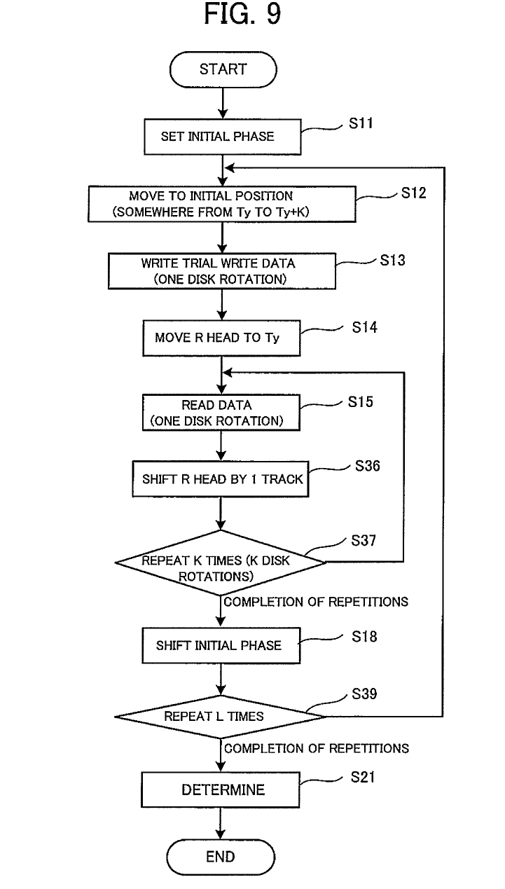

FIG. 9 is a flow chart for explaining the process of determining the optimum access conditions to the magnetic disk illustrated in FIG. 8. The process from the initial value setting step (S11) to the data read step (S15) illustrated in FIG. 9 are the same as those illustrated in FIG. 7, and therefore they are indicated by the same reference numerals. However, in the HDD having the magnetic disk 30 of the present embodiment, data is written (S13) over one round of the track in the trial write region, thereby completing writing to the recording dots at positions deviating to plural extents in the radius direction. Accordingly, in operations for determining the optimum access conditions to the recording dots 36A in the information storage region 25, recording while finely shifting the position of the write head 3b (see S18 of FIG. 7) need not be repeated. Instead, regarding the HDD of the present embodiment, in the operations for determining the optimum access conditions, trial write with phase shift is performed to the second recording dots 36B, 36C and 36D at positions deviating from one another in the radius direction. In more detail, for example, the write head is positioned somewhere between from T_{y} to T_{y+K}, and trial write of one disk rotation is performed. This is possible even in the initial state if K is set large to some extent. Then, data is read while the read head is positioned from T_{y} to T_{y+K} in sequence. This allows the shift amount of the write head to be accurately measured from the number of the track where the maximum signal amplitude value is obtained and its sector number. Also, regarding the HDD of the present embodiment, in the operations for determining the optimum access conditions, data needs to be written plural times while the phase of the write clock is changed to search for a write clock having the optimum phase. Accordingly, for example, in the case where data is written L times while the phase of the write clock is changed in L ways to search for the optimum phase of the write clock, the time needed for the adjustment corresponds to (1+K)×L disk rotations.

The example where recording dots deviate in the radius direction for each sector has been described in the second embodiment. Subsequently, description will be given to the specific third embodiment, in which there are plural arrangement deviations in the radius direction of recording dots in one sector.

In the following description on the third embodiment, the same elements as those in the second embodiment that has been described are indicated by the same reference numerals, and description is given on the differences from the foregoing embodiments.

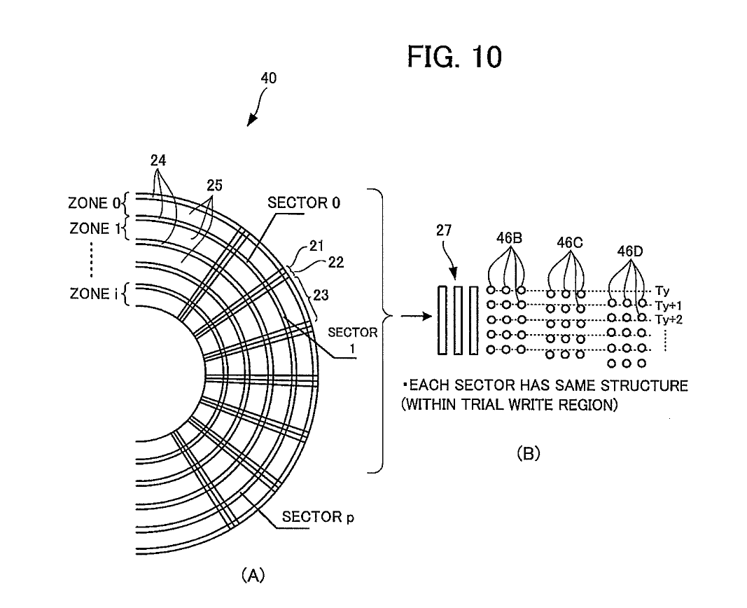

FIG. 10 illustrates a magnetic disk of a HDD being the specific third embodiment of the information storage device.

A half of a magnetic disk 40 is illustrated in Part (A) of FIG. 10, and tracks in plural portions on the magnetic disk 40 are illustrated in linear development in Part (B) of FIG. 10 on an enlarged scale.

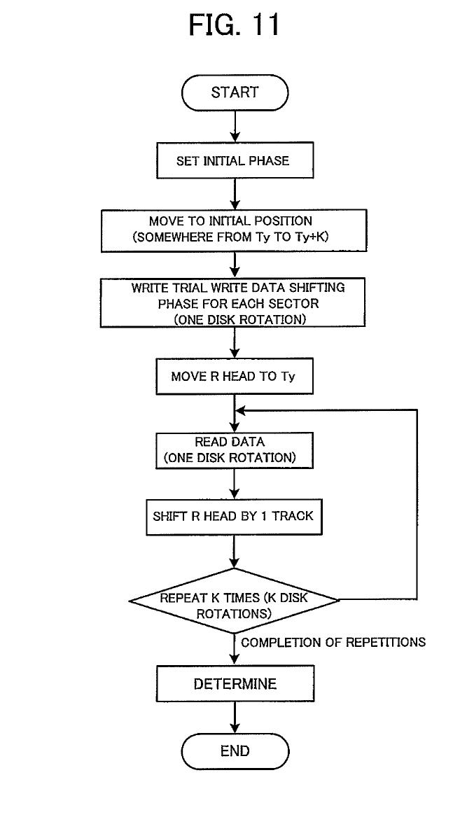

On the magnetic disk 40, recording dots 46B, 46C and 46D, following the write preambles 27, are arranged in a regular array on the tracks T_{y}, T_{y+1}, T_{y+2}, . . . in the trial write region 24. In the trial write region 24, all sectors have the same arrangement pattern such that the recording dots 46B, 46C and 46D arranged in one sector deviate from one another in the radius direction. FIG. 11 is a flow chart for explaining the process of determining the optimum access conditions to the magnetic disk illustrated in FIG. 10. That is, with the magnetic disk 40 of the third embodiment, after the write head is positioned at an initial position between T_{y} and T_{y+K}, trial write is performed over one disk rotation while changing the write phase for each sector. Then, data is read while the read head is sequentially positioned from T_{y} to T_{y+K}. In this way, the shift amount of the write head can be accurately measured and the optimum write clock phase can also be determined from the number of the track where the maximum signal amplitude value is obtained, its sector number and the position in the sector. That is, the number of disk rotations to determine the optimum access conditions is (1+K), further reducing the adjustment time.

Subsequently, description will be given to the fourth embodiment, where recording dots deviate both in the circumferential direction and in the radius direction.

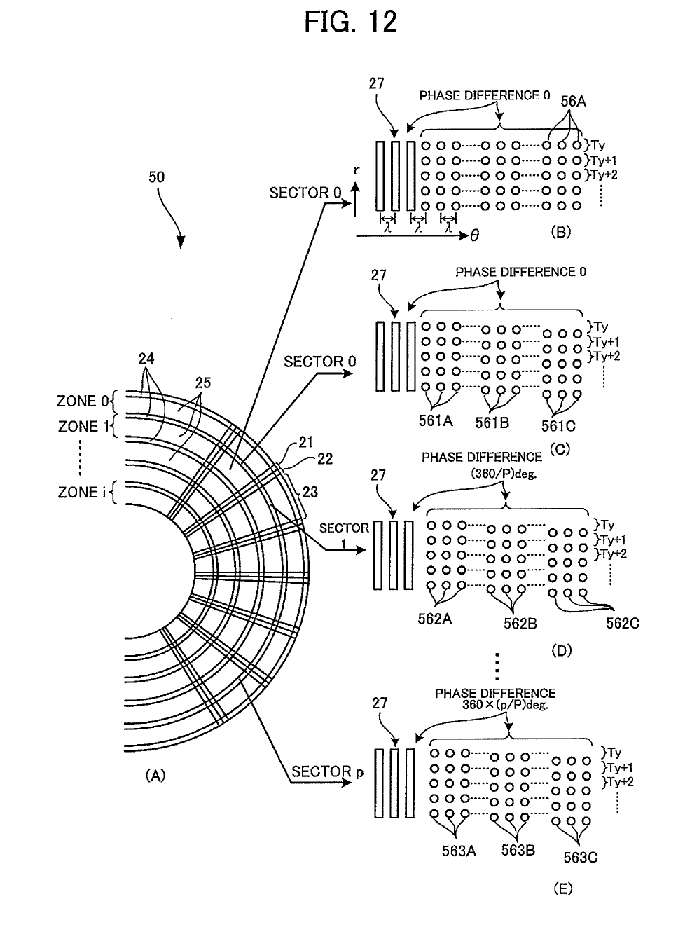

FIG. 12 illustrates a magnetic disk of a HDD being the specific fourth embodiment of the information storage device.

A half of a magnetic disk 50 is illustrated in Part (A) of FIG. 12, and tracks in plural portions on the magnetic disk 50 are illustrated in linear development in Parts (B) to (E) of FIG. 12 on an enlarged scale.

Recording dots 561A, 561B, 561C, 562A, 562B, 562C, 563A, 563B and 563C in the trial write region 24 of the magnetic disk 50 illustrated in FIG. 12 have both deviations in the circumferential direction described on the magnetic disk 2 in the first embodiment and deviations in the radius direction described on the magnetic disk 40 of the third embodiment.

In the trial write region 24 of the magnetic disk 50 illustrated in FIG. 12, the recording dots 561A to 563C are arranged at positions where phase differences with respect to the write preambles 27 are different for each sector. In more detail, arrangement positions of recording dots deviate by 360/P degrees as the number of the sector increases. That is, for example, the second recording dots 561A, 561B and 561C in the sector 0 are arranged at a position where the phase difference with respect to the write preambles 27 is 0 degree, and the recording dots 562A, 562B and 562C in the next sector 1 are arranged at a position where the phase difference with respect to the write preambles 27 is 360/P degrees. The recording dots 563A, 563B and 563C in a sector “p” are arranged at a position where the phase difference with respect to the write preambles 27 is 360p/P degrees.

Further, in the trial write region 24, recording dots arranged in one sector deviate from one another in the radius direction. For example, the recording dots 561A, 561B and 561C in the sector 0 are arranged to deviate from one another in the radius direction. Deviation in the radius direction is the same as in other sectors in the trial write region 24.

With the magnetic disk 50 of the fourth embodiment, data is written to any track in the trial write region 24, thereby completing writing to the recording dots at positions deviating to plural extents both in the radius direction and in the circumferential direction.

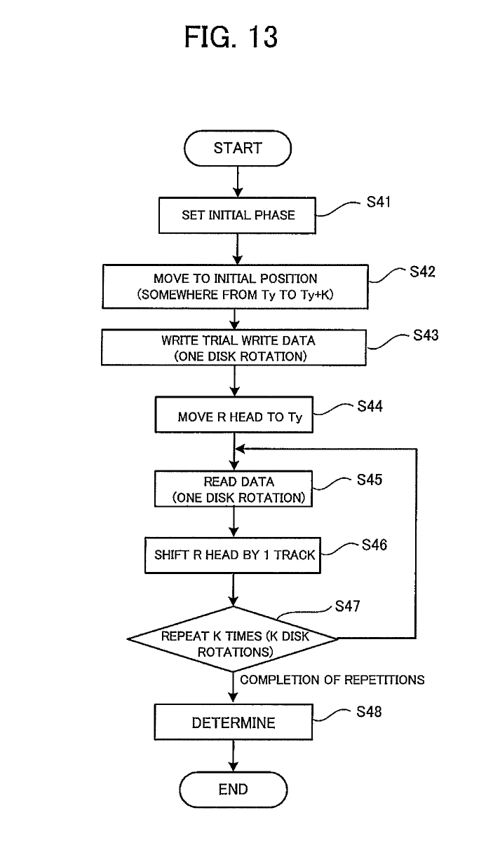

FIG. 13 is a flow chart for explaining the process of determining the optimum access conditions to the magnetic disk illustrated in FIG. 12.

The control circuit 6 moves the write head 3b of the magnetic head 3 to the initial position of trial write between T_{y} and T_{y+K} (S42), and writes data to the trial write region (S43). By this writing, data is written to recording dots arranged at a position deviating both in the circumferential direction and in the radius direction. Then, data is read while the read head is sequentially positioned from T_{y} to T_{y+K}. In this way, the shift amount of the write head can be accurately measured and the optimum write clock phase can also be determined from the number of the track where the maximum signal amplitude value is obtained, its sector number and the position in the sector.

In the above process, the magnetic disk makes one revolution when data is written in step S43 and makes one revolution when data is read in step S45. As a result, the number of rotations of the magnetic disk to determine the optimum access conditions is (1+K). This reduces the adjustment time. There is no difference in advantage regarding the process for determining the optimum access conditions between this fourth embodiment and the third embodiment. However, in the third embodiment, a high-cost circuit that allows phase shift at a high speed needs to be provided in order to perform trial write while shifting the phase for each sector. The fourth embodiment has an advantage in device cost over the third embodiment.

In the foregoing description on the specific embodiments, recording dots arranged on concentric tracks are indicated as one example of the recording dots arranged in an array circumferentially in the information recording medium described in “SUMMARY”. However, the recording dots arranged in an array circumferentially may be those arranged in a spiral shape other than in a concentric shape.

In the foregoing description on the specific embodiments, the write preambles arranged at mutual intervals that have a ratio to the mutual intervals of the recording dots 26A of 1:1 are indicated as one example of the magnetic pattern of the present invention. However, the magnetic pattern herein may be those recorded at mutual intervals having an integer ratio to the mutual intervals of the recording dots. For example, the mutual intervals of the array may be integer times the mutual intervals of the recording dots.

According to the basic embodiment of the information recording medium, second recording dots are arranged in an array circumferentially, but plural kinds of positions with different deviation amounts from the positions in accordance with the regulation appear. Therefore, information is recorded on the second recording dots along the round, thereby performing recording that complies with plural access conditions. Thus, the number of changes of access conditions can be reduced.

As described above, the embodiments of the information recording medium and the information storage device can reduce the adjustment time for access conditions.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information recording medium, comprising:
a substrate;
a plurality of first recording dots which are arranged in an array circumferentially in accordance with a predetermined regulation at mutual intervals in accordance with the regulation at a position in accordance with the regulation and are used to magnetically record information; and
a plurality of second recording dots which are arranged in an array circumferentially in accordance with the regulation at mutual intervals in accordance with the regulation, in which a plurality of kinds of positions having different deviation amounts from the position in accordance with the regulation appear in one round of the array, and which are used to magnetically record information.

2. The information recording medium according to claim 1, wherein the second recording dot is arranged at a position deviating in a direction along the round of the array from the position in accordance with the regulation of the array of the first recording dot.

3. The information recording medium according to claim 1, wherein the second recording dot is arranged at a position deviating in a direction intersecting the round of the array from the position in accordance with the regulation of the array of the first recording dot.

4. The information recording medium according to claim 1, wherein the plurality of first recording dots and the plurality of second recording dots are arranged in an array at equal intervals in accordance with the regulation with respect to a direction along the round of the array.

5. The information recording medium according to claim 1, further comprising, on a round of the array, a magnetic pattern recorded at mutual intervals having an integer ratio to the mutual intervals of the recording dots in a direction along the round.

6. An information storage device, comprising:
an information recording medium comprising:
a substrate,
a plurality of first recording dots which are arranged in an array circumferentially in accordance with a predetermined regulation at mutual intervals in accordance with the regulation at a position in accordance with the regulation and are used to magnetically record information, and
a plurality of second recording dots which are arranged in an array circumferentially in accordance with the regulation at mutual intervals in accordance with the regulation, in which a plurality of kinds of positions having different deviation amounts from the position in accordance with the regulation appear in one round of the array, and which are used to magnetically record information; and
a recording section that records information on the first recording dot and the second recording dot while relatively moving along a round of the information recording medium.

7. The information storage device according to claim 6, wherein the second recording dot is arranged at a position deviating in a direction along the round of the array from the position in accordance with the regulation of the array of the first recording dot.

8. The information storage device according to claim 6, wherein the second recording dot is arranged at a position deviating in a direction intersecting the round of the array from the position in accordance with the regulation of the array of the first recording dot.

9. The information storage device according to claim 6, wherein the plurality of first recording dots and the plurality of second recording dots are arranged in an array at equal intervals in accordance with the regulation with respect to a direction along the round of the array.

10. The information storage device according to claim 6, wherein the information recording medium further comprises, on a round of the array, a magnetic pattern recorded at mutual intervals having an integer ratio to the mutual intervals of the recording dots in a direction along the round.
